(19) United States
(12) Patent Application Publication
(10) Pub. No.: US 2008/0007402 A1
(43) Pub. Date: Jan. 10, 2008

(54) Portable monitoring assembly

(75) Inventor: Chin-Hung Cheng, Chung Ho City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Lucent Trans Electronic Co., Ltd., Chung Ho City (TW)

(21) Appl. No.: 11/481,640

(22) Filed: Jul. 6, 2006

(51) Int. Cl. G08B 13/00; H04N 7/18

(52) U.S. Cl. 340/541; 348/155

(57) ABSTRACT

A portable monitoring assembly has a cellular phone, an operation base, a phone controlling process and an image analyzing process. The cellular phone is capable of capturing images. The operation base has an alarming module and a connecting interface. The connecting interface is mounted on the operation base to detachablely connect to the cellular phone. The phone controlling process is installed in the cellular phone to establish a communication between the cellular phone and the operation base. The image analyzing process controls the alarming module to output an alarm if any moving object in the captured images is detected. Because the cellular phone and the operation base are easily and conveniently to be carried by a user, the user can set the monitoring assembly at any desired position.

### BACKGROUND OF THE INVENTION

1. Field of the Invention

The present invention relates to a monitoring assembly, and more particularly to a monitoring assembly composed of a cellular phone and an operation base to monitor and record images as a monitoring device.

2. Description of Related Art

A monitoring device is used to monitor and record images and comprises a video camera to capture images and a host machine to store and process the image data. However, the monitoring device is immobile and not portable. Users can not easily set the monitoring device in a place and then remove the monitoring device when finishing monitoring.

To overcome the shortcomings, the present invention provides a portable monitoring assembly to mitigate or obviate the aforementioned problems.

### SUMMARY OF THE INVENTION

The main objective of the invention is to provide a portable monitoring assembly, which is composed of a cellular phone and an operation base to monitor and record images as a monitoring device.

A portable monitoring assembly in accordance with the present invention comprises a cellular phone, an operation base, a phone controlling process and an image analyzing process. The cellular phone is capable of capturing images. The operation base has an alarming module and a connecting interface. The alarming module is used to output an alarm. The connecting interface is mounted on the operation base to detachablely connect to the cellular phone. The phone controlling module is installed in the cellular phone to establish a communication between the cellular phone and the operation base. The image analyzing process controls the alarming module to output the alarm if any moving object in the captured images is detected.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a monitoring assembly in accordance with the present invention;

FIG. 2 is a functional block diagram of the monitoring assembly as shown in FIG. 1;

FIG. 3 is an exploded perspective view of the monitoring assembly as shown in FIG. 1;

FIG. 4 is a flow chart of the image analyzing process installed in a processor;

FIG. 5 is a functional block diagram of a second embodiment of a monitoring assembly in accordance with the present invention; and

FIG. 6 is a flow chart of the image analyzing process installed in a cellular phone as shown in FIG. 5.

### DETAILED DESCRIPTION OF PREFERRED EMBODIMENT

A portable monitoring assembly comprises a cellular phone, an operation base, a phone controlling process and an image analyzing process.

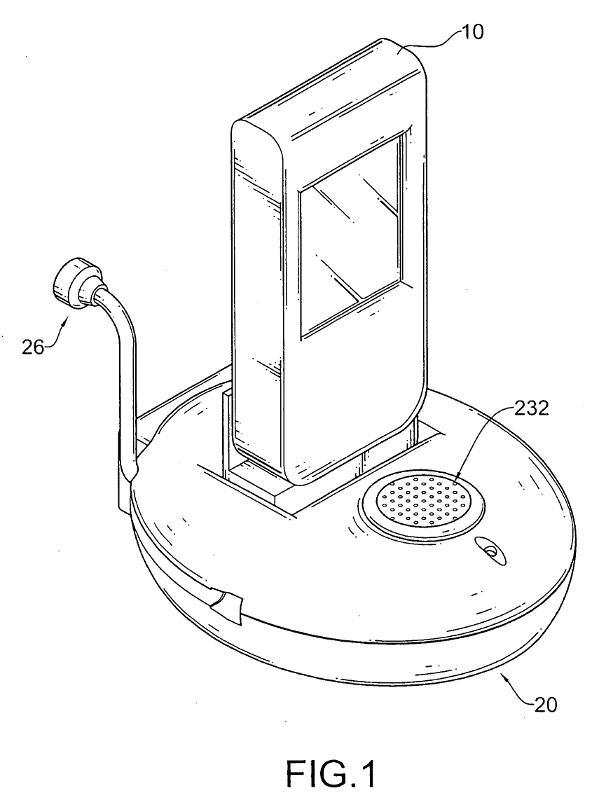

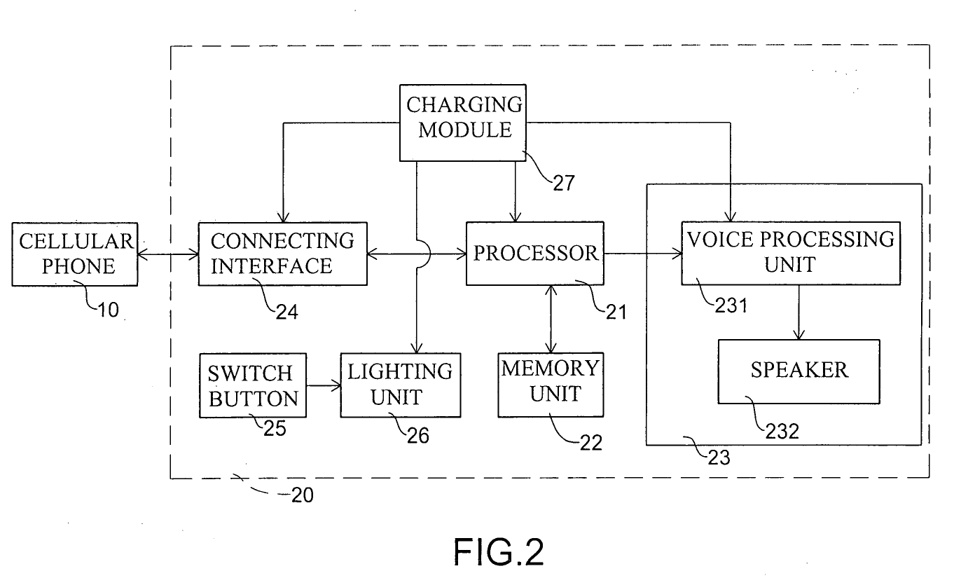

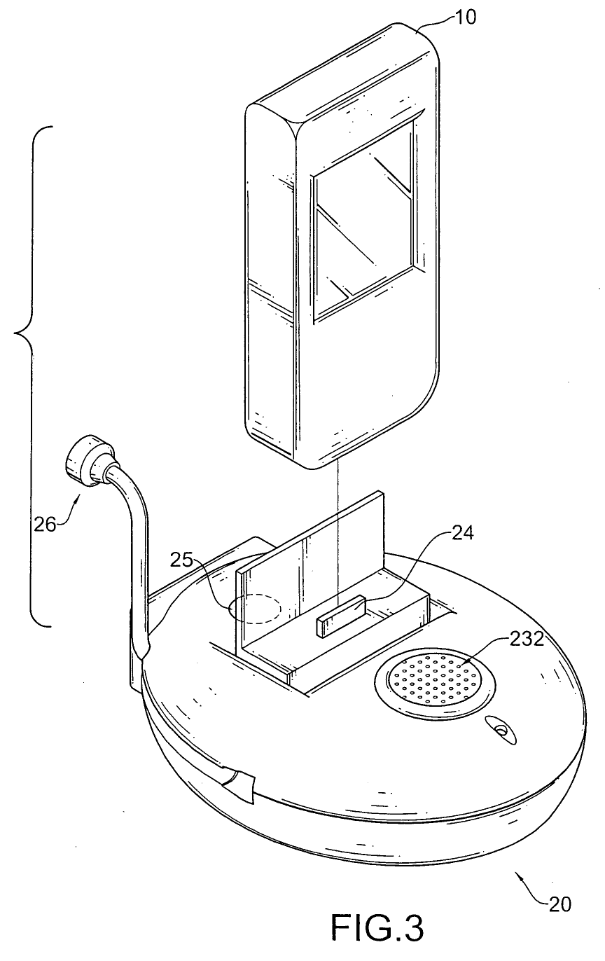

With reference to FIGS. 1-3, a first embodiment of the portable monitoring assembly is depicted.

The cellular phone (10) comprises an optional Universal Serial Bus (USB) connector and has a camera to capture images.

The operation base (20) has a processor (21), a memory unit (22), an alarming module (23), a connecting interface (24), a switch button (25), a lighting unit (26) and a charging module (27).

The processor (21) executes a cellular phone recognizing process.

The memory unit (22) is connected to the processor (21) to store image data.

The alarming module (23) is controlled by the processor (21) to output an alarm and comprises a voice processing unit (231) and a speaker (232). The voice processing unit (231) is connected to the processor (21) to process voice data. The speaker (232) is connected to the voice processing unit (231) to output the alarm.

The connecting interface (24), which can be a USB port, is exposed through the operation base (20) and connected the cellular phone (10) to the operation base (20) to transfer data between the cellular phone (10) and the operation base (20). The connecting interface (24) can further be rotatablely mounted on the operating base (20) to provide a wide recording angle for the cellular phone (10).

The switch button (25) is exposed through the operation base (20).

The lighting unit (26) is connected to the switch button (25) and is mounted on the operation base (20) as an auxiliary light source when capturing images. The lighting unit (26) is controlled by the switch button (25).

The charging module (27) supplies an operating voltage to the processor (21), the voice processing unit (231) and the lighting unit (26) and charges the cellular phone (10)

The phone controlling process is installed in the cellular phone (10) to establish a communication between the cellular phone (10) and the operation base (20). When a cellular phone is electronically connected to the operation base (20), the processor (21) executes the cellular phone recognizing process to determine whether or not the cellular phone has the phone controlling process. If not, the processor (21) installs the phone controlling process in the cellular phone.

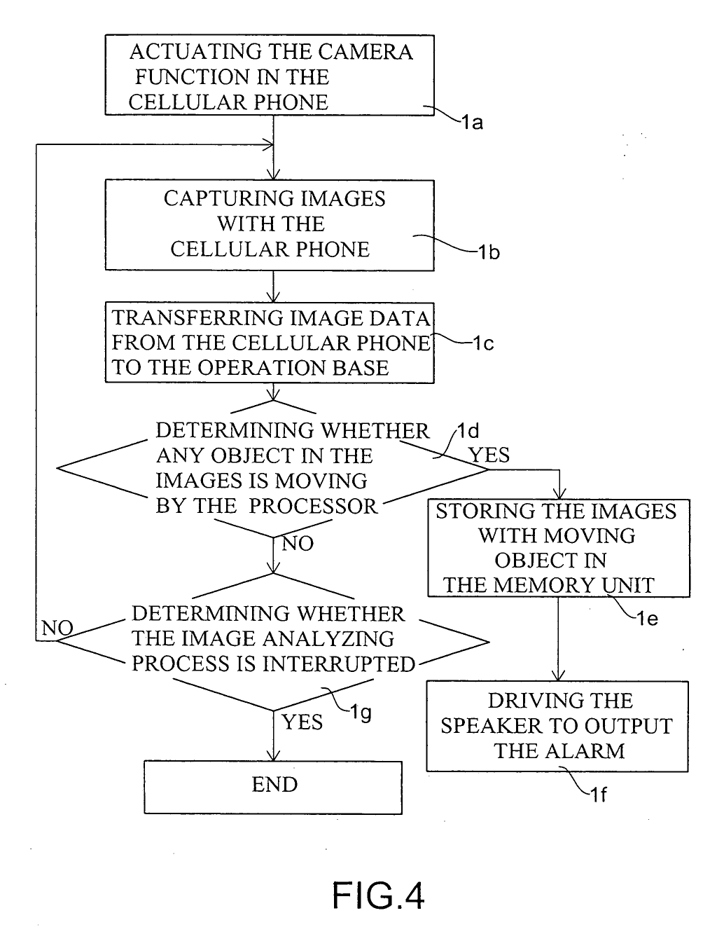

The image analyzing process is installed in the processor (21) and controls the alarming module (23) to generate the alarm if any object in the captured images is moving. With reference to FIG. 4, the image analyzing process comprises steps of (1a) actuating the camera function in the cellular phone (10), (1b) capturing images with the cellular phone (10), (1c) transferring image data from the cellular phone (10) to the operation base (20), (1d) determining whether any object in the images is moving by the processor (21), (1e) storing the images with moving object in the memory unit (22), (1f) driving the speaker (232) to output the alarm, (1g) determining whether the image analyzing process is interrupted and (1h) continuing to capture images with the cellular phone (10) if the image analyzing process is not interrupted.

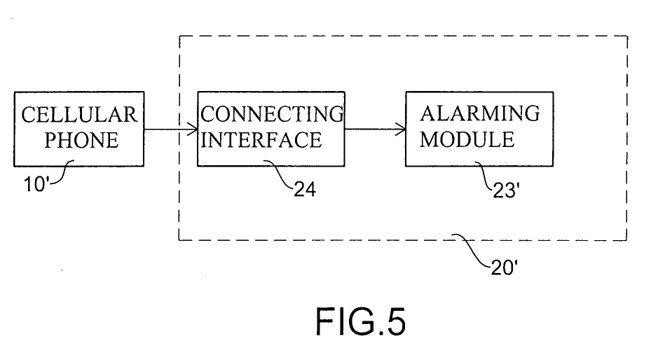

With reference to FIG. 5, a second embodiment of the portable monitoring assembly is depicted.

The cellular phone (10′) has a camera to capture images and is capable to process and store image data.

The operation base (20′) has an alarming module (23′) and a connecting interface (24). The alarming module (23′) is controlled by the cellular phone (10′) to output an alarm. The connecting interface (24) is exposed through the operation base (20′) and connected to the cellular phone (10′) for transferring data between the cellular phone (10′) and the operation base (20′). The connecting interface (24) can further be rotatablely mounted on the operating base (20′) to provide a wide recording angle for the cellular phone (10′).

The phone controlling process is installed in the cellular phone (10′) to establish a communication between the cellular phone (10′) and the operation base (20′).

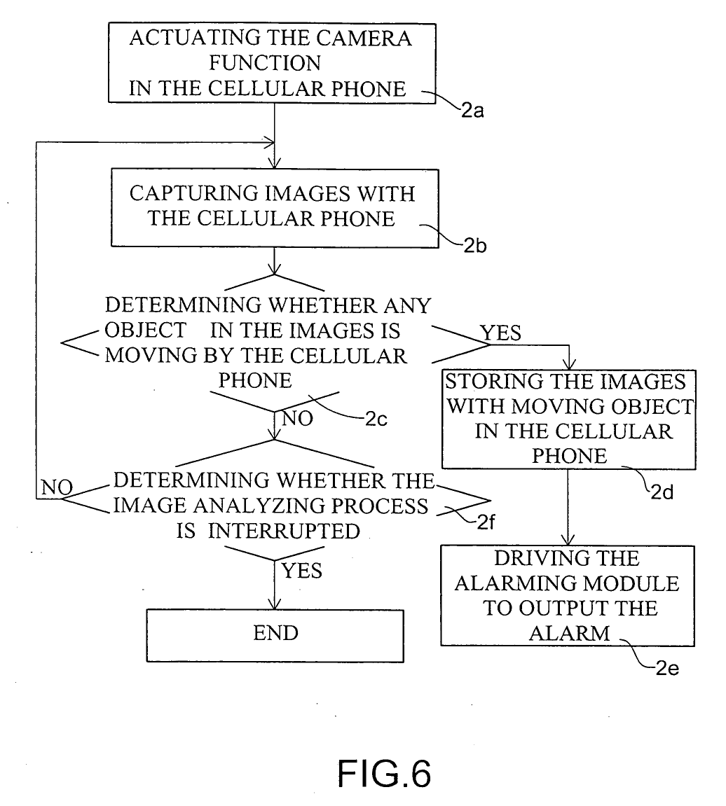

With reference to FIG. 6, the image analyzing process is installed in the cellular phone (10′) and comprises steps of (2a) actuating the camera function in the cellular phone ( 10′), (2b) capturing images with the cellular phone (10 ′), (2c) determining whether any object in the images is moving by the cellular phone (10′), (2d) storing the images with moving object in the cellular phone (10′), (2e) driving the alarming module (23′) to output the alarm, (2f) determining whether the image analyzing process is interrupted and (2g) continuing to capture images with the cellular phone (10′) if the image analyzing process is not interrupted.

With such a monitoring assembly, the cellular phone (10, 10′) and the operation base (20, 20′) of the present invention are easily and conveniently to be carried by a user. Therefore, the user can set the monitoring assembly of the present invention at any position to monitor surrounding statuses.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A portable monitoring assembly comprising:
a cellular phone being capable of capturing images;
an operation base comprising
an alarming module being used to output an alarm; and
a connecting interface mounted on the operation base to detachablely connect to the cellular phone;
a phone controlling process installed in the cellular phone to establish a communication between the cellular phone and the operation base; and
an image analyzing process controlling the alarming module to output the alarm if any moving object in the captured images is detected.

2. The monitoring assembly as claimed in claim 1, wherein the image analyzing process is installed in the cellular phone further being capable to process and store image data and comprises steps of:
actuating the camera function in the cellular phone;
capturing images with the cellular phone;
determining whether any object in the images is moving by the cellular phone;
storing the images with moving object in the cellular phone;
driving the alarming module to output the alarm;
determining whether the image analyzing process is interrupted; and
continuing to capture images with the cellular phone if the image analyzing process is, not interrupted.

3. The monitoring assembly as claimed in claim 1, wherein the operation base further comprises
a processor connected to the alarming module and the connecting interface and using a cellular phone recognizing process to determine whether or not the cellular phone has the phone controlling process, wherein if no phone controlling process is detected, the processor installs the phone controlling process in the cellular phone; and
a memory unit connected to the processor to store image data.

4. The monitoring assembly as claimed in claim 3, wherein the alarming module comprises
a voice processing unit connected to the processor to process voice data; and
a speaker connected to the voice processing unit to output the alarm.

5. The monitoring assembly as claimed in claim 4, wherein the image analyzing process is installed in the processor and comprises steps of:
actuating the camera function in the cellular phone;
capturing images with the cellular phone;
transferring image data from the cellular phone to the operation base;
determining whether any object in the images is moving by the processor;
storing the images with moving object in the memory unit;
driving the speaker to output the alarm;
determining whether the image analyzing process is interrupted; and
continuing to capture images with the cellular phone if the image analyzing process is not interrupted.

6. The monitoring assembly as claimed in claim 1, wherein the connecting interface is rotatablely mounted on the operation base to provide a wide recording angle for the cellular phone.

7. The monitoring assembly as claimed in claim 1, wherein the operation base further comprises
a switch button mounted on the operation base; and
a lighting unit connected to the switch button and mounted on the operation base as an auxiliary light source when capturing images.

8. The monitoring assembly as claimed in claim 1, wherein the operation base further comprises a charging module that connects to the connecting interface to charge the cellular phone.

9. The monitoring assembly as claimed in claim 4, wherein the operation base further comprises a charging module that supplies an operating voltage to the processor and the voice processing unit and connects to the connecting interface to charge the cellular phone.

10. The monitoring assembly as claimed in claim 7, wherein the operation base further comprises a charging module that supplies an operating voltage to the lighting unit and connects to the connecting interface to charge the cellular phone.
